(19) United States
(12) Patent Application Publication
(10) Pub. No.: US 2023/0362781 A1
(43) Pub. Date: Nov. 9, 2023

(54) Precise Location-Based Routing of Calls

(71) Applicant: T-MOBILE INNOVATIONS LLC, Overland Park, KS (US)

(72) Inventors: Patrick James O'Gallagher, Bangor, PA (US); Dennis Romero, Frisco, TX (US); Adriano Santos, Ocean, NJ (US)

(73) Assignee: T-MOBILE INNOVATIONS LLC, Overland Park, KS (US)

(21) Appl. No.: 18/142,702

(22) Filed: May 3, 2023

Related U.S. Application Data
(60) Provisional application No. 63/338,015, filed on May 3, 2022.

(51) Int. Cl. H04W 40/20

(52) U.S. Cl. CPC H04W 40/20

(57) ABSTRACT

Systems and methods are provided for precise location-based routing of calls. After a user device originates a non-short code call to a jurisdiction specific number, one or more networked computer processing components utilize the location of the originating user device to generate a location-based translated number. The location-based translated number combines the higher-precision location of the originating device with the destination number, causing the call to be routed to a destination more likely to be associated with the jurisdiction from which the call originated.

### CROSS-REFERENCE TO RELATED APPLICATIONS

This application claims the benefit of Provisional U.S. Pat. App. No. 63/338,015 entitled “Precise Location-Based Routing of Calls,” filed on May 3, 2022, the entirety of which is incorporated herein by reference.

### SUMMARY

The present disclosure is directed, in part, to routing non-short code calls based with increased precision based on the location of the call origin, substantially as shown in and/or described in connection with at least one of the figures, and as set forth more completely in the claims.

In aspects set forth herein, calls are routed to jurisdiction-specific call centers with increased precision based on the origin of the call. In the US, calls are routed to jurisdiction-specific call centers when users dial short code calls (such as 811 for utility locating or 211 for community services); however, when non-short code calls to jurisdiction-specific destinations (e.g., call centers) are dialed from a user equipment (UE) that is wirelessly connected to a mobile telecommunication network, coarse location information is used to route the call. Particularly in border regions, where coarse location information may lead to calls being routed to the incorrect call center, an improved solution for precise call routing is needed. According to the present disclosure, a UE location is combined with a particular number translation and routing scheme to ensure that non-short code calls are routed to the proper jurisdiction-specific destination with significantly improved precision than conventional solutions.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary computing environment suitable for use in implementations of the present disclosure;

FIG. 2 depicts a diagram of an exemplary network environment in which implementations of the present disclosure may be employed; and

FIG. 3 depicts a flow diagram of an exemplary method for uplink power management for extended range communication, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. Unless otherwise indicated, acronyms are used in their common sense in the telecommunication arts as one skilled in the art would readily comprehend. Further, various technical terms are used throughout this description. An illustrative resource that fleshes out various aspects of these terms can be found in Newton's Telecom Dictionary, 31st Edition (2018).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions. Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently. Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional wireless telecommunications network employs a plurality of base stations to wirelessly transmit signals to a user device and wirelessly receive signals from the user device. When a user device originates a non-short code call (e.g., a toll free call) that is supposed to be handled based on jurisdiction, conventional solutions may consider the major trading area or other geographic area associated with a radio network used to route the call from the user device; however, when the particular radio network spans multiple different jurisdictions for the purposes of routing jurisdiction-specific calls, the user device may be passed to the incorrect jurisdictional destination. That is, existing solutions do not precisely route non-short code calls and can result in calls being routed to a jurisdiction-specific destination not associated with the jurisdiction from which the call originated. In an example, if a user device originates a call to the toll free number for poison control, the call should be routed to the poison control center associated with the user device's location; however, if the user device is located at or near a jurisdictional boundary and is served by a base station of a radio network that is associated with a different jurisdiction, the poison control call may be routed to the incorrect jurisdiction.

In order to increase the precision of routing non-short code calls, the present disclosure combines device-specific location information with a routing protocol that ensures calls are routed to the correct jurisdictional destination.

Accordingly, a first aspect of the present disclosure is directed to a method for precise location-based routing of calls. The method comprises receiving an indication that a user device has originated a call to a non-short code, jurisdiction specific phone number. The method further comprises routing the call to one or more computer processing components configured to determine an origination location of the user device when the user device originated the call. The method further comprises generating a location-based translated number comprising a first portion representing the non-short code, jurisdiction specific phone number and a second portion representing the origination location. The method further comprises routing the location-based translated number to a jurisdiction-specific destination corresponding to both the non-short code, jurisdiction specific phone number and the origination location.

A second aspect of the present disclosure is directed to a non-readable computer readable media having instructions stored thereon, that when executed by one or more computer processing components, perform a method for precise location-based routing of calls. The method comprises receiving an indication that a user device has originated a call to a non-short code, jurisdiction specific phone number. The method further comprises routing the call to one or more computer processing components configured to determine an origination location of the user device when the user device originated the call. The method further comprises generating a location-based translated number comprising a first portion representing the non-short code, jurisdiction specific phone number and a second portion representing the origination location. The method further comprises routing the location-based translated number to a jurisdiction-specific destination corresponding to both the non-short code, jurisdiction specific phone number and the origination location.

Another aspect of the present disclosure is directed to a system for precise location-based routing of calls. The system comprises a first computer processing component configured to receive an indication that a user device has originated a call to a non-short code, jurisdiction specific phone number. The system further comprises a second computer processing component configured to determine an origination location of the user device when the user device originated the call. The system further comprises a third computer processing component configured to generate a location-based translated number comprising a first portion representing the non-short code, jurisdiction specific phone number and a second portion representing the origination location, and to cause the location-based translated number to be routed to a jurisdiction-specific destination corresponding to both the non-short code, jurisdiction specific phone number and the origination location.

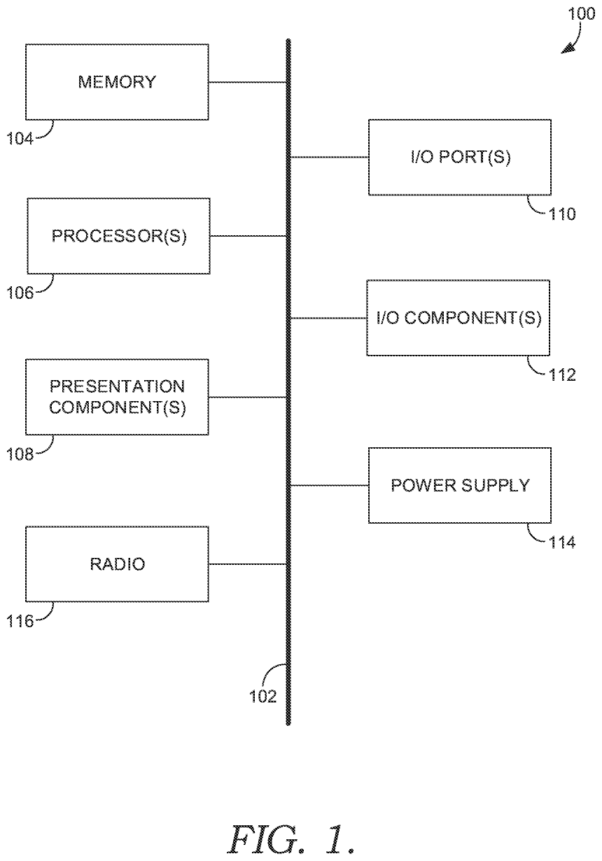

Referring to FIG. 1, a diagram is depicted of an exemplary computing environment suitable for use in implementations of the present disclosure. In particular, the exemplary computer environment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 may be a UE, WCD, or other user device, capable of two-way wireless communications with an access point. Some non-limiting examples of the computing device 100 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

Radio 116 represents a radio that facilitates communication with a wireless telecommunications network. In aspects, the radio 116 utilizes one or more transmitters, receivers, and antennas to communicate with the wireless telecommunications network on a first downlink/uplink channel. Though only one radio is depicted in FIG. 1, it is expressly conceived that the computing device 100 may have more than one radio, and/or more than one transmitter, receiver, and antenna for the purposes of communicating with the wireless telecommunications network on multiple discrete downlink/uplink channels, at one or more wireless nodes. Illustrative wireless telecommunications technologies include CDMA, GPRS, TDMA, GSM, and the like. Radio 116 might additionally or alternatively facilitate other types of wireless communications including Wi-Fi, WiMAX, LTE, or other VoIP communications. As can be appreciated, in various embodiments, radio 116 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

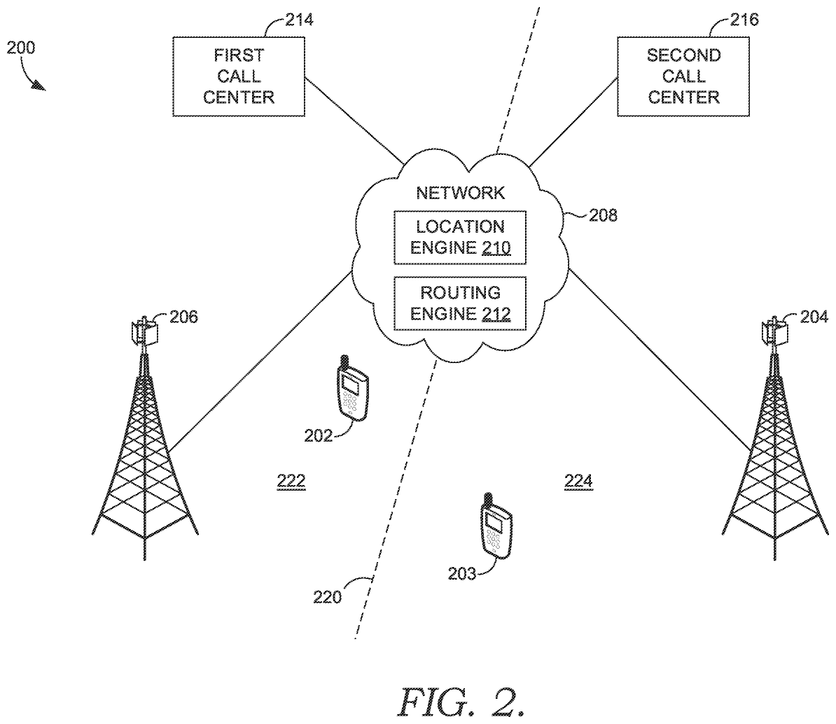

Turning now to FIG. 2, a network environment 200 is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated. The network environment 200 includes a first user device 202 and a second user device 203, one or more base stations such as a first base station 206 and a second base station 204, a network 208, and a plurality of jurisdiction-specific destinations such as a first call center 214 and a second call center 216. The network environment 200 is particularly useful for illustrating scenarios where a user device such as the first user device 202 or the second user device 203 is located at or near a jurisdictional boundary, such as boundary 220. The first user device 202 may be said to be located in a first jurisdiction 222 and the second user device may be said to be located in a second jurisdiction 224, wherein the boundary 220 is the line of demarcation between the first jurisdiction 222 and the second jurisdiction 224. Each of the first jurisdiction 222 and the second jurisdiction 224 may be a national, state, county, or city boundary or other boundary such as a metropolitan statistical area. In instances where the first user device 202 or the second user device 203 originate a jurisdiction-specific call, it may be required by regulatory or other requirements to be routed to a destination associated with the jurisdiction from which the call originated. For example, calls to poison control use the same phone number regardless of where the call originates, but calls are required to be routed to the jurisdiction's poison control call center from which the call originates. That is, if the first user device 202 is located in the first jurisdiction 222 and calls poison control, the call is required to be routed to the first call center 214 associated with the first jurisdiction 222 (not the second call center 216 associated with the second jurisdiction 224).

As mentioned, network or market boundaries have conventionally been utilized as the basis for routing non-short code calls such as poison control calls. Unfortunately, network or market boundaries do not always align with jurisdictional boundaries and can result in calls being routed incorrectly. Consider the Philadelphia, PA area, where calls originating on both sides of the Pennsylvania/New Jersey line may be served by a radio network associated with the Philadelphia major trading area (MTA). Based on the call originating from the Philadelphia MTA, the call may be routed to the Pennsylvania poison control center, regardless of whether the call actually originated in Pennsylvania or New Jersey. This could be because base stations across jurisdictional boundaries could be in the same MTA (e.g., the first base station 206 and the second base station 204 are both part of an MTA chiefly associated with the first jurisdiction 222) or because a user device in one jurisdiction is connected to a base station in another jurisdiction (e.g., the second user device 203 could be attached to the first base station 206 in the first jurisdiction 222 instead of the second base station 204 in the second jurisdiction 224, even though the second user device 203 is located in the second jurisdiction 224). In order to solve the problems that conventional solutions present, the present disclosure includes determining device location information. In one aspect, the device location may be provided by the device itself, based on a satellite-based location service running on the user device (e.g., Global Positioning System (GPS)) or other fine location information data obtained and processed by the user device itself and reported to the network. In other aspects, a telecommunication network may use one or more location determining processes (e.g., triangulation, range/bearing) to determine the location of the user device.

When a user device such as the first user device 202 originates a non-short code call and is attached to the first base station 206, the call is routed to the telecommunications network 208. One or more components of the network 208 (e.g., a control function or switching center) determines that the call is a non-short code, jurisdiction-specific call, and routes it to a routing engine 212 via a location engine 210. The location engine 210 is generally configured to associate the location information of a particular user device with a jurisdiction in which it originates a call (e.g., the first user device 202 with the first jurisdiction 222). The location engine 210 may utilize the fine-location information provided by the first user device 202 (e.g., using a GPS or other precise location service(s) of the first user device 202) or may utilize information about the first base station (e.g., a cell ID or cell global identity (CGI)) and cross-check it against the known location of base stations/cells. The location engine 210 may take the form of any one or more computer processing components that are configured to lookup jurisdictional information based on location or a base station identifier input (e.g., a gateway mobile location center (GMLC)). Once the location engine 210 determines that the location of the first user device 202 (or the first base station to which the first user device 202 is attached) is located within the first jurisdiction 222, the information is passed to the routing engine 212.

The routing engine 212 is generally configured to translate the originating call to a translated sequence based on the location information passed from the location engine 210. The routing engine may take the form of any one or more computer processing components configured to receive location information from the location engine 210 and create a location-based translated number using the location information (e.g., a short code gateway mobile location center (GMLC)). The routing engine 212 first receives the location information associated with the call origin location and determines, based on that information which destination to route the call. Using the earlier example, the routing engine 212 may receive information from the location engine 210 that a call should be routed to the Pennsylvania call center based on a call originating in Philadelphia, PA or that the call should be routed to the New Jersey call center based on the call originating in Camden, NJ (across the Delaware river from Philadelphia). After the routing engine determines the correct destination for the call, the routing engine 212 creates a location-based translated number.

In one aspect, creating the location-based translated number comprises appending the non-short code number dialed by a user device such as the first user device 202 with call origin location to create a location-based sequence. For example, if the first user device 202 originates a call to poison control (a jurisdiction-specific, non-short code number) that is determined to be from the first jurisdiction 222 (e.g., Philadelphia, PA), the routing engine 212 may append the non-short code number (in this example, 18002221222) with a sequence representing the location where the call originated (e.g., NPA NXX of the originating location, such as 215303 representing Philadelphia)—instead of using static location identifiers associated with the calling user device (i.e., using the NPA-NXX of the location where call originated, not the NPA-NXX portion of the user device's phone number/URI that initiated the call). That is, the location-based translated number in the preceding example would comprise 21530318002221222. The location-based translated number could then be used to route the call directly to the appropriate, jurisdiction-specific correct call center (e.g., the first call center 214) or one or intermediary services/components could facilitate routing the call, such as by routing the location-based translated number to a session border controller (SBC) where any additional processing to the location-based translated number could be performed before passing the call to a toll free provider, which can utilize the sequence representing the location (e.g., the NPA-NXX such as 215303) for routing to the first call center 214 (as opposed to routing the call to the second call center 216, which might have happened if the second call center was associated with the second jurisdiction 224, the second jurisdiction was Camden, NJ, and the second user device 203 initiated the call from the second jurisdiction 224, having an NPA-NXX of 856870).

In another aspect, the location-based translated number may be an entirely different sequence than the non-short code number that was dialed by a user, wherein the location-based translated number comprises a first portion representing the dialed call (e.g., translating the non-short code into a short code sequence) and a second portion representing the location information associated with the call origin location. For example, if the second user device 203 calls a jurisdiction-specific, non-short code number such as poison control from the second jurisdiction 224, the number could be identified by the network 208 as being a jurisdiction specific, non-short code call and route the call to the routing engine 212 via the location engine 210, which may have determined that the NPA-NXX associated with the second jurisdiction is 856870 (in this example, Camden, NJ, as opposed to Philadelphia, PA). The routing engine 212 may generate an entirely new sequence of digits to represent the non-short code poison control call and the location; for example, a pre-assigned sequence such as 9980 could be used essentially as a short code to represent the non-short code poison control call, and it could be appended with the NPA-NXX (or other location-specific sequence). In the preceding example, the routing engine 212 would create the location-based translated number of 9980856870. The location-based translated number could then be routed to one or more components or services of the network 208, which could be used to directly route the call to the second call center 224 or could be further processed in order to facilitate the proper routing.

In yet another aspect, a combination approach could be implemented. When the first user device 202 originates a jurisdiction-specific, non-short code call (e.g., poison control), the routing engine 212 may translate the number into the location-based translated number, such as by creating a new sequence comprising a representative short code sequence and a location-specific sequence (e.g., 9980215303). The translated number may then be routed to other aspects of the network 208 based on the inclusion of the representative short code sequence (e.g., 9980), where it is further translated into a sequence comprising the original dialed number and at least a portion of the location-based translated number; for example, 9980215303 (created by the routing engine 212) may be routed to one or more networked computing components (e.g., an SBC or component with similar functionality) where it may be translated into as sequence that includes the originally-dialed non-short code number (e.g., 1121530318002221222, wherein the 9980 has been replaced by the original number, the location-specific sequence remains in the number) in order to effectuate proper routing by the SBC and/or toll free service/provider, and the sequence of “11” has been added as a toll free indicator used to route the call to the toll free service/provider. In another non-limiting example, if a subscriber dials 8002221222 in the state of Georgia, it may be routed to the routing engine 212 (e.g., a GMLC or component with similar functionality), translated to 9980404422 (NPA-NXX associated with Atlanta, GA), routed to one or more networked computing components for further routing (e.g., a BGCF, MSS, or other component(s) having similar functionality) where translations are in place to look for steering digits (in this example, 9980). Upon identifying the steering digits, the one or more networked computing components translate the location-based translated number to a sequence (e.g., 1140442218002221222) comprising the location information (e.g., 404422), a toll-free routing indicator (e.g., 11), and the destination number (e.g., 18002221222). Based on comprising the toll-free routing indicator (e.g., 11), the call can then be routed to another networked computer component (e.g., a session border controller (SBC)), where the toll-free routing indicator could be removed, routing the remaining sequence 40442218002221222 to the toll-free provider. The toll-free provider will query a toll-free database and send the call to the appropriate destination based on the location information portion of the remaining sequence (e.g., 404422), resulting in the call being routed to the Georgia poison control center.

Aspects of the present disclosure may be utilized with telecommunication systems utilizing the session initiation protocol. If the first user device 202 originates a call to a non-short code, jurisdiction specific number, the call will be routed to the network 208 via the first base station 206. One or more components of the network 208, such as BGCF, MSS, or other component with switching or similar capabilities, will route the call through the process of precision routing described herein. One or more networked components, such as the location engine 210 obtains location information of the originating call, according to any one or more aspects described herein. The routing engine 212 receives the location information and creates a location-based translated number according to any one or more aspects described herein. One or more networked computing components, such as an SBC may be used to detect a toll-free routing indicator and modify/create a SIP P-asserted Identity (PAI) header comprising a location identifier (e.g., a sequence representing NPA-NXX) and one or more other headers for routing the call (e.g., SIP To, SIP Request, and the like). With the location identifier mated to the number having increased precision, the call originated by the first user device can be routed according to standard SIP protocols to the first call center 214, whether directly by the network 208 or via a toll free service provider.

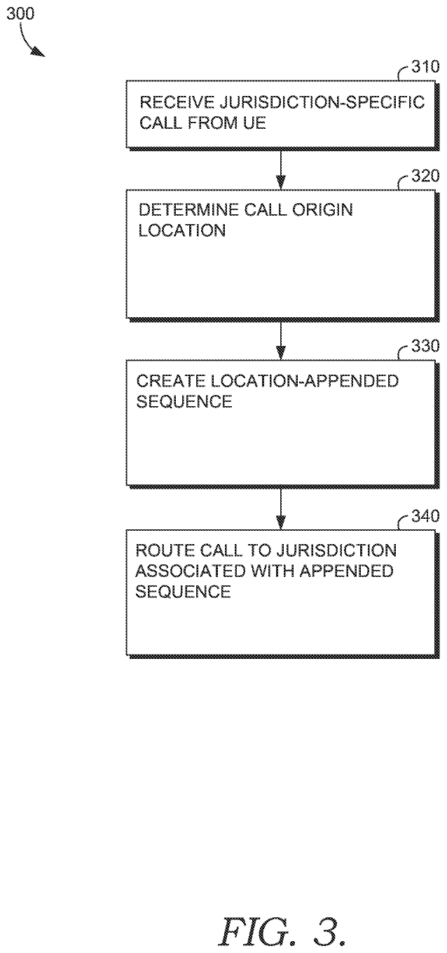

Turning now to FIG. 3, a flow chart is provided for precise location-based routing of calls. At a first step 310, the method comprises receiving an indication that a user device is placing a non-short code jurisdiction-specific call by comparing the dialed number to a routing table comprising jurisdiction-specific phone URI/phone numbers, or according to any one or more aspects described with respect to FIG. 2. At a second step 320, the origination location associated with a user device making the non-short code jurisdiction-specific call is determined, according to any one or more aspects described herein with respect to FIG. 2. At a third step 330, a location-based translated number is created based at least in part on the non-short code, jurisdiction-specific number that was initiated by the user device and the origination location of the originating user device, according to any one or more aspects described herein with respect to FIG. 2. At a fourth step 340, the call is routed to a jurisdiction-specific destination using the location-based translated number, according to any one or more aspects described with respect to FIG. 2.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for precise location-based routing of calls, the method comprising:
receiving an indication that a user device has originated a call to a non-short code jurisdiction specific phone number;
determining an origination location of the user device when the user device originated the call;
generating a location-based translated number comprising a first portion representing the non-short code jurisdiction specific phone number and a second portion representing the origination location; and
routing the location-based translated number to a jurisdiction-specific destination corresponding to both the non-short code jurisdiction specific phone number and the origination location.

2. The method of claim 1, wherein determining the location of the user device is based on a location provided by the user device and determined by one or more satellite-based location services running on the user device.

3. The method of claim 1, wherein the non-short code jurisdiction specific phone number is associated with a plurality of jurisdiction-specific call centers, and wherein the plurality of jurisdiction-specific call centers comprises a first call center associated with a first jurisdiction and a second call center associated with a second jurisdiction.

4. The method of claim 3, wherein the second portion of the location-based translated number representing the origination location comprises a numbering plan area (NPA) and a central office within the NPA (NXX) of the originating location.

5. The method of claim 4, wherein the first portion of the location-based translated number is the non-short code jurisdiction specific phone number dialed by the user device.

6. The method of 4, wherein the first portion of the location-based translated number is a short code sequence representing the non-short code jurisdiction specific phone number.

7. The method of claim 4, wherein the non-short code jurisdiction specific phone number is a toll-free number.

8. The method of claim 7, wherein routing the location-based translated number to the jurisdiction-specific destination comprises routing the location-based translated number to a session border controller.

9. The method of claim 8, wherein the method further comprises appending the location-based translated number with a numeric toll-free indicator.

10. The method of claim 9, wherein the method further comprises routing the location-based translated number to a toll free service provider based on a determination, by the session border controller, that the location-based translated number is appended with the numeric toll-free indicator.

11. The method of claim 1, wherein determining the location of the user device is based on identifying one or more base stations used by the user device to originate the call.

12. A system A method for precise location-based routing of calls comprising:
a base station configured to receive an indication that a user device has originated a call to a non-short code jurisdiction specific phone number associated with a plurality of jurisdiction-specific call centers, wherein the user device is wirelessly connected to the base station, and wherein the plurality of jurisdiction-specific call centers comprises a first call center associated with a first jurisdiction and a second call center associated with a second jurisdiction; and
one or more networked computer processing components configured to:
determine an origination location of the user device when the user device originated the call; and
route the call to the first call center based on a determination that the origination location of the user device when the user device originated the call is inside the first jurisdiction.

13. The system of claim 12, wherein the one or more networked computer processing components is further configured to generate a location-based translated number comprising a first portion representing the non-short code jurisdiction specific phone number and a second portion representing the origination location.

14. The system of claim 13, wherein determining the origination location of the user device is based on a location provided by the user device and determined by one or more satellite-based location services running on the user device.

15. The system of claim 14, wherein the second portion of the location-based translated number representing the origination location comprises a numbering plan area (NPA) and a central office within the NPA (NXX) of the originating location.

16. The system of claim 15, wherein the first portion of the location-based translated number is the non-short code jurisdiction specific phone number dialed by the user device.

17. The system of claim 15, wherein the first portion of the location-based translated number is a short code sequence representing the non-short code jurisdiction specific phone number.

18. The system of claim 15, wherein the one or more networked computer processing components are further configured to append the location-based translated number with a numeric toll-free indicator.

19. The system of claim 18, wherein the one or more networked computer processing components comprises a session border controller, and wherein the session border controller is configured to route the location-based translated number to a toll free service provider based on a determination by the session border controller that the location-based translated number is appended with the numeric toll-free indicator.

20. A method for precise location-based routing of calls, the method comprising:
receiving an indication that a user device has originated a call to a non-short code jurisdiction specific phone number, wherein the non-short code jurisdiction specific phone number is associated with a plurality of jurisdiction-specific call centers, the plurality of jurisdiction-specific call centers comprising a first call center associated with a first jurisdiction and a second call center associated with a second jurisdiction;
determining an origination location of the user device when the user device originated the call is within the first jurisdiction;
generating a location-based translated number comprising a first portion representing the non-short code jurisdiction specific phone number and a second portion representing the origination location; and
routing, using the location-based translated number, the call to the first call center based on a determination that the first call center corresponds to the non-short code jurisdiction specific phone number and the origination location.
